(19) United States
(12) Patent Application Publication
(10) Pub. No.: US 2019/0208761 A1
(43) Pub. Date: Jul. 11, 2019

(54) NEW FORMULATION FOR SPRAYING BIOPESTICIDES AND SPRAYING APPARATUS TO CONTROL PEST

(71) Applicants: UNIVERSITÉ LAVAL, Quebec (CA); ANATIS BIOPROTECTION INC., Laval (CA)

(72) Inventors: Mohamed KHELIFI, Quebec (CA); Pascal GAUTHIER, Levis (CA); Silvia TODOROVA, Montreal (CA); Mylène ST-ONGE, St-Jacques-le-Mineur (CA)

(21) Appl. No.: 16/233,216

(22) Filed: Dec. 27, 2018

(30) Foreign Application Priority Data
Jan. 10, 2018 (CA) 2991499

(51) Int. Cl. A01M 7/00; A01N 63/00

(52) U.S. Cl. CPC A01M 7/0042; A01M 7/0085; A01M 7/006; A01N 25/04; A01M 7/0053; A01N 63/00; A01M 7/0089

(57) ABSTRACT

The present invention discloses a formulation and an apparatus for spraying a biopesticide against corn borer and other crop pests.

### CROSS-REFERENCE TO RELATED APPLICATION

This application claims the benefit of Canadian patent application 2 991 499 filed on Jan. 10, 2018 and entitled “NEW FORMULATION FOR SPRAYING BIOPESTICIDES AND SPRAYING APPARATUS TO CONTROL PEST”. This Canadian patent application is incorporated herein by reference in its entirety.

### FIELD OF THE INVENTION

The technical field relates to a formulation for spraying biopesticide to control pest in agriculture. It also relates to a spraying apparatus for spraying the formulation, in the form of a viscous solution.

### BACKGROUND OF THE INVENTION

The European corn borer, Ostrinia nubilalis (Hubner), is the major insect pest of sweet corn in Quebec and around the world (Ferland et al., 2000). In North America and Europe, the European corn borer causes 20% of yield losses (Siegfried and Hellmich, 2012).

The European corn borer begins by attacking plant leaves, then dig tunnels in cornstalks. Currently, chemical insecticides are mainly used to control this insect pest. Chemical hazards for human health and the environment are well documented. Despite government efforts to reduce the use of chemicals in agriculture, pesticides sales have steadily increased over the time. Nevertheless, there are some interesting alternatives to chemicals to control the European corn borer (Musser et al., 2006).

The use of genetically modified corn (Bt) can efficiently control the corn borer. However, a resistance can be developed by the corn borer in the absence of a non-Bt corn refuge (Pereira et al., 2008; Siegfried and Hellmich, 2012). The biocontrol is another alternative to pesticides. Trichogramma wasps have been used for many decades in sweet corn fields and have been proven to be effective in controlling the European corn borer (Boisclair et al., 2011; Gardner and Giles, 1997). However, field application of Trichogramma using trichocards is more expensive than the use of chemical pesticides. Trichogramma pupae are stick on waxed cardboards called trichocards and must be handled by hand to the field. The preparation of pupae is expensive for beneficial insect producers and trichocard manipulations are time consuming for farmers. Boisclair et al. (2011) investigated the cost of many corn borer control methods. They indicated that a rate of 400 000 pupae/ha is approximately three times more expensive than the use of permethrine pesticide. Furthermore, the manual distribution of trichocards is laborious and discouraged producers to adopt it. Mechanical pupae distribution would highly facilitate Trichogramma spreading in the field and consequently reduce the production cost of this beneficial insect.

An exhaustive literature review revealed that only very few research studies regarding mechanical application methods of biopesticides have been carried out. Few sprayers were tested with Trichogramma pupae (Mills et al., 1996; Morrison et al., 1998; Gardner and Giles, 1997). Obtained results showed that the spraying solutions were in general not adequate and had sometimes a negative impact on the sprayed pupae. Different emergence rates ranging from 40% to 92% have been reported (Zimmermann and Wührer, 2010; Mills et al., 1996; Jalali et al., 2005; Kienzle et al., 2012; and Zimmermann and Wührer, 2010). This indicates that it is possible to immerse and spray biopesticides. The main objective herein is therefore to investigate the technical feasibility of spraying fragile biopesticides such as Trichogramma ostriniae pupae to control the European corn borer in sweet corn crops. For this purpose, many laboratory trials have been carried out on different aqueous spraying solutions to determine the most appropriate one allowing a good scattering of biopesticides in the spraying media and an adequate adhesion on the target crop. The impacts of immersing biopesticides in the aqueous solutions as well as their emergence rate after being sprayed have also been investigated.

In view of the above, there is a need for a pest formulation and a spraying apparatus which would be able to overcome or at least minimize some of the above-discussed prior art concerns.

### SUMMARY OF THE INVENTION

According to a general aspect of the disclosure, there is provided A spraying apparatus for spraying a biological agent suspended in a viscous aqueous solution, the spraying apparatus comprising a frame; a supply tank adapted to contain the viscous aqueous solution; spray nozzles spaced apart along the frame and configured to spray the viscous aqueous solution; and a positive displacement pump in fluid communication with the supply tank and the spray nozzles, the pump being adapted to receive the viscous aqueous solution from the supply tank and deliver the viscous aqueous solution at a predetermined spraying pressure to the spray nozzles.

In an embodiment, the frame, the supply tank, the spray nozzles and the positive displacement pump are sized and configured for aerial spraying.

In an embodiment, the frame, the supply tank, the spray nozzles and the positive displacement pump are sized and configured for greenhouse spraying.

In an embodiment, the frame, the supply tank, the spray nozzles and the positive displacement pump are sized and configured for portable spraying.

In an embodiment, the frame comprises a lateral frame post defining a spraying height and a support arm extending from the lateral frame post to define a spraying width.

In an embodiment, the spray nozzles are spaced apart along the spraying width.

In an embodiment, the supply tank and the positive displacement pump are mounted to the frame.

In an embodiment, the spraying height is adjustable with respect to a ground surface.

In an embodiment, the spraying height is adjustable with the support arm being removably mounted to the lateral frame post.

In an embodiment, the lateral frame post and the support arm comprise a plurality of height adjustment holes for adjusting the height of the support arm.

In an embodiment, the spray nozzles are sized and shaped to allow spraying the viscous aqueous solution at a pressure ranging between about 10 and 50 psi.

In an embodiment, the spray nozzles are sized and shaped to allow spraying the viscous aqueous solution at a pressure ranging between about 15 and 20 psi.

In an embodiment, the spray nozzles have an outlet orifice larger than about 0.30 mm.

In an embodiment, the spray nozzles have flat spray tips.

In an embodiment, the spraying width is defined by a pair of support arms extending on opposite sides of a pair of lateral frame posts.

In an embodiment, each support arm comprises at least one spray nozzle.

In an embodiment, each support arm comprises a plurality of spray nozzles.

In an embodiment, the plurality of spray nozzles is evenly spaced apart along the spraying width.

In an embodiment, the support arm extends substantially horizontally from the lateral frame post.

In an embodiment, the spray nozzles are directed substantially downwardly.

In an embodiment, the predetermined spraying pressure ranges between 10 and 50 psi.

In an embodiment, the predetermined spraying pressure ranges between 15 and 20 psi.

In an embodiment, the positive displacement pump is a diaphragm pump.

In an embodiment, the positive displacement pump is sized to deliver the viscous aqueous solution to the spray nozzles at a flow rate between 4 L/min and 55 L/min.

In an embodiment, the spraying apparatus further comprises a pressure switch operatively connected to the positive displacement pump.

In an embodiment, the framework is movable in an operation direction.

In an embodiment, the lateral frame post and the support arm define a frame plane, the operation direction being substantially normal to the frame plane.

In an embodiment, the spraying apparatus further comprises a towing structure secured to the framework adapted to be attached to a tow vehicle.

In an embodiment, the spraying apparatus further comprises at least one wheel mounted to the framework.

In an embodiment, the support arm is pivotably mounted to the framework, the spraying apparatus being selectively configurable in a transport configuration and an operation configuration wherein the support arm extends outwardly from the lateral frame post, the support arm extending along the lateral frame post in the transport configuration.

In an embodiment, the spraying apparatus further comprises a control valve for controlling the flow of the viscous aqueous solution between the supply tank and the pump.

According to another general aspect, there is provided a mobile spraying apparatus for spraying crops with a viscous liquid, the spraying apparatus comprising a framework comprising a movable platform, a pair of frame posts extending upwardly from the platform to define a spraying height and boom assemblies extending on opposite sides of the frame posts to define a spraying width, the frame posts and the boom assemblies defining a frame plane and the platform being movable in an operation direction substantially normal to the frame plane; a supply tank attached to the platform of the framework and adapted to contain the viscous liquid; a plurality of spray nozzles evenly spaced apart along the spraying width and directed substantially downwardly, the nozzles being sized to spray the viscous liquid at a predetermined flow rate; and a positive displacement pump mounted to the platform of the framework, the pump being in fluid communication with the supply tank and the plurality of spray nozzles, the pump being sized to receive the viscous liquid from the supply tank and deliver the viscous liquid at a predetermined spraying pressure to the spray nozzles.

In an embodiment, the spraying height is adjustable, wherein the boom assemblies are slidably mounted to the frame posts.

In an embodiment, the spraying apparatus further comprises a boom support structure, the boom assemblies being hingedly connected to the boom support structure.

In an embodiment, the spraying apparatus is selectively configurable in a transport configuration and an operation configuration wherein the boom assemblies extend outwardly from the frame posts, the boom assemblies being folded on opposite sides of the frame posts and substantially parallel thereto in the transport configuration.

In an embodiment, the movable platform comprises a pair of wheels.

In an embodiment, the spraying apparatus further comprises flexible tubing fluidly coupling the supply tank to the pump and the pump to the spray nozzles.

In an embodiment, the predetermined flow rate ranges between 4 L/min and 55 L/min.

In an embodiment, the predetermined spraying pressure ranges between 15 and 20 psi.

According to another general aspect of the disclosure, there is provided a formulation comprising an aqueous solution of xanthan gum and guar gum, for use in making a suspension for a biological agent.

In an embodiment, xanthan gum is in aqueous solution at a concentration between about 1 to 7 g/L and guar gum is in aqueous solution at a concentration between about 1 to 7 g/L.

In an embodiment, xanthan gum and guar gum are in a ratio of about 3:5 to 5:3.

In an embodiment, the formulation further comprises the biological agent suspended therein.

In an embodiment, the biological agent comprises an insect, a mite, or any combination thereof.

In an embodiment, the insect is an egg, a larva, a pupae or an adult.

In an embodiment, the insect is from the genus Trichogramma.

In an embodiment, the insect is Trichogramma ostriniae.

In an embodiment, the insect is Trichogramma ostriniae pupae.

In an embodiment, the biological agent has a survival rate of at least 50% after a 10 hours immersion in the formulation.

In an embodiment, the biological agent has a survival rate of at least 80% after a 3-hour immersion in the formulation.

In an embodiment, the formulation is for use in mechanical spreading of a biological agent on a surface.

In an embodiment, the surface is a forest, a garden, a greenhouse, an agricultural field, or any combination thereof.

In an embodiment, the surface comprises a crop and/or a plant.

In an embodiment, the crop comprises: field crops (canola, cereals, corn, beans, forages, soybeans, or any combination thereof), fruit crops (apples, berries, grapes, tender fruits, or any combination thereof), vegetable crops, specialty crops (agroforestry, herbs, tobacco, turfs, hemp, ginseng, hops, or any combination thereof).

In an embodiment, the crop and/or plant comprises leaves.

In an embodiment, the crop is corn.

In an embodiment, the biological agent has a survival rate of at least 50% after being spread on the surface.

In an embodiment, the formulation is adapted to dry into an irreversible and/or insoluble film after mechanical spreading on the surface.

In an embodiment, the composition adheres to the surface after mechanical spreading.

In an embodiment, the composition adheres to an upper and/or under side of the leaves after mechanical spreading.

In an embodiment, the composition when spread on the surface is resistant to leaching caused by rain and/or wind.

In an embodiment, the mechanical spreading of the biological agent suspended therein is carried out by spraying.

In an embodiment, the spraying is performed with the spraying apparatus according to the present disclosure.

According to another general aspect of the disclosure, there is provided a method for control and/or treatment of a pest comprising the steps of making a formulation comprising xanthan gum and guar gum, wherein xanthan gum and guar gum are each at concentrations between 1 to 7 g/L; obtaining a biological agent; suspending the biological agent in the formulation to form a biopesticide suspension; and mechanically spreading the biopesticide suspension on a surface.

In an embodiment, the method further comprises the step of pouring the biopesticide suspension in the spraying apparatus according to the present disclosure; spraying the biopesticide suspension on the surface.

In an embodiment, the biological agent comprises an insect, a mite, or any combination thereof.

In an embodiment, the insect is an egg, a larva, a pupae or an adult.

In an embodiment, the insect is from the genus Trichogramma.

In an embodiment, the insect is Trichogramma ostriniae.

In an embodiment, the insect is Trichogramma ostriniae pupae.

In an embodiment, xanthan gum and guar gum are in a ratio of about 3:5 to 5:3.

In an embodiment, xanthan gum and guar gum are in a ratio of about 1:1.

In an embodiment, the surface is a forest, a garden, a greenhouse, an agricultural field, or any combination thereof.

In an embodiment, the surface comprises a crop and/or a plant.

In an embodiment, the crop and/or plant comprises leaves.

In an embodiment, the crop is corn.

In an embodiment, the biological agent has a survival rate of at least 50% after being mechanically spread.

In an embodiment, the biopesticide suspension is adapted to dry into an irreversible and/or insoluble film after being mechanically spread.

In an embodiment, the biopesticide suspension adheres to the surface after being mechanically spread.

In an embodiment, the biopesticide suspension adheres to an upper and/or under side of the leaves after being mechanically spread.

In an embodiment, the biopesticide suspension when mechanically spread on the surface is resistant to leaching caused by rain and/or wind.

In an embodiment, the pest is a plant, virus, bacteria, fungi, insect, moth, animal or any combination thereof.

In an embodiment, the pest is Ostrinia nubilalis.

According to another general aspect of the disclosure, there is provide a kit for the control and/or treatment of a pest, the kit comprising an aliquot of xanthan gum; an aliquot of guar gum; instructions for making a formulation of the guar gum and xanthan gum; instructions for suspending a biological agent in the formulation; and instructions for spreading the solution on a surface.

In an embodiment, the kit further comprises the biological agent.

In an embodiment, the biological agent is Trichogramma ostriniae pupae.

In an embodiment, the kit further comprises a container.

The present description relates to a spraying apparatus for spraying a biological agent suspended in a viscous aqueous solution, the spraying apparatus comprising a frame; a supply tank adapted to contain the viscous aqueous solution; spray nozzles spaced apart along the frame and configured to spray the viscous aqueous solution; and a positive displacement pump in fluid communication with the supply tank and the spray nozzles, the pump being adapted to receive the viscous aqueous solution from the supply tank and deliver the viscous aqueous solution at a predetermined spraying pressure to the spray nozzles.

The present description relates to a mobile spraying apparatus for spraying crops with a viscous liquid, the spraying apparatus comprising a framework comprising a movable platform, a pair of frame posts extending upwardly from the platform to define a spraying height and boom assemblies extending on opposite sides of the frame posts to define a spraying width, the frame posts and the boom assemblies defining a frame plane and the platform being movable in an operation direction substantially normal to the frame plane; a supply tank attached to the platform of the framework and adapted to contain the viscous liquid; a plurality of spray nozzles evenly spaced apart along the spraying width and directed substantially downwardly, the nozzles being sized to spray the viscous liquid at a predetermined flow rate; and a positive displacement pump mounted to the platform of the framework, the pump being in fluid communication with the supply tank and the plurality of spray nozzles, the pump being sized to receive the viscous liquid from the supply tank and deliver the viscous liquid at a predetermined spraying pressure to the spray nozzles.

The present description relates to a formulation comprising an aqueous solution of xanthan gum and guar gum for use in making a suspension for a biological agent.

The present description relates to a composition comprising xanthan gum and guar gum in aqueous solution for use in mechanical spreading of a biological agent on a surface.

The present description relates to a method for control and/or treatment of a pest comprising: making an formulation comprising xanthan gum and guar gum, wherein xanthan gum and guar gum are each at concentrations between 3 g/L to 7 g/L; obtaining a biological agent; suspending the biological agent in the formulation to form a biopesticide suspension; and mechanically spreading the biopesticide suspension, on a surface.

The present description relates to a kit for the control and/or treatment of a pest, said kit comprising: xanthan gum; guar gum; instructions for making a formulation of the guar gum and xanthan gum; instructions for suspending a biological agent in the solution; and instructions for spreading the solution on a surface.

The present description relates to a composition comprising a biological agent suspended in a solution of xanthan gum and guar gum.

### Detailed Description of the Invention

### DESCRIPTION OF THE FIGURES

FIG. 1 is a front perspective view of a spraying apparatus, according to an embodiment.

FIG. 2 is a rear perspective view of the spraying apparatus shown in FIG. 1.

FIG. 3 is a front elevation view of the spraying apparatus shown in FIG. 1.

FIG. 4 is a rear elevation view of the spraying apparatus shown in FIG. 1.

FIG. 5 is a front perspective view of the spraying apparatus shown in FIG. 1, with a framework configured in a transport configuration.

FIG. 6 is a rear perspective view of the spraying apparatus shown in FIG. 5.

FIG. 7 Emergence rate of pupae versus immersion time for solutions 1 and 2. Vertical bars represent the standard deviation of the means.

FIG. 8 Crushing rate of Trichogramma pupae as a function of operation time of the pressure regulator.

FIG. 9 (Left) Modified backpack sprayer with diaphragm pump (Shurflo 8000-343-236) and battery (12 V, 7.5 Ah). (Right) Five nozzles spraying boom.

FIG. 10 Emergence rates of immersed and not sprayed (control) and sprayed Trichogramma pupae immersed in solution 2 for nozzles 1 and 2.

FIG. 11 Apparent viscosity as a function of the rotation speed of the rod for solutions made of xanthan gum (GX) 3 g/L, xanthan gum (GX) 4 g/L, guar gum (GG) 6 g/L and a mixture of xanthan gum (GX) 2 g/L+guar gum 2 g/L at 20° C.

FIG. 12 Experimental setup of each treatment (Control, solution containing xanthan gum only, solution containing xanthan gum and guar gum) in triplicate, both for the upper (U) and under (D) sides of corn leaves.

FIG. 13 Adhesion rates on the underside and upper side of corn leaves of sprayed pupae immersed in concentrated solution 2 (4 g/L) and in the mixture of solutions 1 and 2.

It will be noted that throughout the appended drawings, like features are identified by like reference numerals.

### ABBREVIATIONS AND DEFINITIONS

### Definitions

The term “about” as used herein refers to a margin of + or −10% of the number indicated. For sake of precision, the term about when used in conjunction with, for example: 90% means 90%+/−9% i.e. from 81% to 99%. More precisely, the term about refers to + or −5% of the number indicated, where for example: 90% means 90%+/−4.5% i.e. from 86.5% to 94.5%.

As used herein the singular forms “a”, “and”, and “the” include plural referents unless the context clearly dictates otherwise. Thus, for example, reference to “a cell” includes a plurality of such cells and reference to “the culture” includes reference to one or more cultures and equivalents thereof known to those skilled in the art, and so forth. All technical and scientific terms used herein have the same meaning as commonly understood to one of ordinary skill in the art to which this invention belongs unless clearly indicated otherwise.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps.

As used herein, the expression “aqueous solution” refers to a solution in which the solvent is water, including tap water; ocean or seawater; brackish water; sources of freshwater, including lakes, rivers, stream, bogs, ponds, marshes, runoff from the thawing of snow or ice; springs, groundwater, and aquifers; and precipitation. In one aspect, the aqueous solution comprises a thickening agent which improves the viscosity of the solution, such as, but not limited to, alginic acid, agar, carrageenan, guar gum, xanthan gum, locust bean gum, pectin, gelatin, collagen. In another aspect, the aqueous solution comprises xanthan gum in a concentration of about 2 g/L, 3 g/L, 4 g/L, 5 g/L, 6 g/L, 7 g/L, 8 g/L, 9 g/L or 10 g/L. In another aspect, the aqueous solution comprises guar gum in a concentration of about 2 g/L, 3 g/L, 4 g/L, 5 g/L, 6 g/L, 7 g/L, 8 g/L, 9 g/L or 10 g/L. In a further aspect, the aqueous solution comprises xanthan gum and guar gum respectively in the concentrations listed above and in a ratio of about 1:10, 2:5, 3:10, 2:5, 1:2, 3:5, 7:10, 4:5 or 1:1.

As used herein, the term “viscosity” refers to a value determined from the ratio of shear stress to shear rate (see, e.g., Considine, D. M. & Considine, G. D., Encyclopedia of Chemistry, 4th Edition, Van Nostrand, Reinhold, N.Y., 1984) essentially as follows:

F/A=μ*V/L (Equation 1)

where F/A=shear stress (force per unit area), μ=a proportionality constant (viscosity), and
V/L=the velocity per layer thickness (shear rate).

From this relationship, the ratio of shear stress to shear rate defines viscosity. Measurements of shear stress and shear rate are typically determined using parallel plate rheometery performed under selected conditions (for example, a temperature of about 37° C.). Other methods for the determination of viscosity include, measurement of a kinematic viscosity using a viscometer, for example, a Cannon-Fenske viscometer, a Ubbelohde viscometer for the Cannon-Fenske opaque solution, or a Ostwald viscometer. Generally, suspensions of the present description have a viscosity sufficient to prevent particles suspended therein (suspenoid) from settling during storage and use.

In one aspect, the formulation, the composition, the aqueous solution and/or the biopesticide suspension as disclosed herein exhibit pseudoplasticity. A pseudoplastic solution and/or suspension shows a high viscosity at low shear rate, so as to avoid settling of the suspenoid; and shows a low viscosity at higher shear rate, so as to permit flow and pumping of the solution and/or suspension.

As used herein, the expression “xanthan gum” means the extracellularly produced gum made by the heteropolysaccharide-producing bacterium Xanthomonas campestris which can be used as a thickening agent in various contexts. Industrial xanthan gum is commercially available and suited for the different aspects disclosed herein.

As used herein, the expression “guar gum” refers to the gum extracted from the seeds of the guar bean plant Cyamopsis tetragonoloba which can be used as a thickening agent in various contexts. Industrial guar gum is commercially available and suited for the different aspects disclosed herein.

As used herein, the term “suspension” refers to a mixture of at least two substances: the suspended phase (suspenoid), which includes a substance in a finely divided state, which is uniformly distributed through the second substance, called the suspending phase (or dispersing medium). The suspending phase may be a gas, a liquid, or a solid and the suspended phase may also be any of these. In one aspect, the biological agent forms the suspended phase and the aqueous solution the dispersing medium, such that the biological agent is uniformly dispersed in the aqueous solution. In such case the solution is referred to as a biopesticide suspension.

As used herein, the term “biological agent” refers to biologically-active pathogenic agent originally derived from natural sources which is useful in the control or prevention of plant-, soil- or water-borne pest infestation by adversely affecting the existence or growth of the target pest, particularly insects. Such control can comprise, but is not limited to, a complete killing action, eradication, arresting in growth, reduction in number, induction of plant resistance or any combination of these actions. Biological agents include, but are not limited to, insects, mites, or any combination thereof.

Insects may be used as biological agents at different stage of their development.

For example, eggs, larvae, pupae and adults can be used as biological agents. In one aspect, the biological agent is a Trichogramma spp. Trichogramma spp. include species such as, but not limited to: Trichogramma aomoriense, Trichogramma brassicae, Trichogramma minutum, Trichogramma evanescens, Trichogramma atopovirilia, Trichogramma brevicapillum, Trichogramma deion, Trichogramma exiguum, Trichogramma fuentesi, Trichogramma nubilale, Trichogramma platneri, Trichogramma pretiosum, Trichogramma thalense, Trichogramma japonicum, Trichogramma carverae and Trichogramma ostriniae. In one aspect, the biological agent is Trichogramma ostriniae pupae.

As used herein, the term “pest” refers to organisms and microorganisms, including pathogens, that negatively affect animals and plants by colonizing, attacking or infecting them, and includes those organisms that spread disease and/or damage the animal and plant and/or compete for host nutrients. As used herein, the term “pest” for plants and/or crops are vertebrate animals other than man, any invertebrate animal, any plant growing where not wanted, any insect, mite, fungus, bacterium, virus or other microorganism. Exemplary pests are those which adversely affect agricultural yields and include pathogenic fungi, pathogenic nematodes, pathogenic bacteria, pathogenic viruses, insects, weed plants, and weed seeds. Pests adversely affect agricultural substances, e.g., by causing damage, disease, reductions in yield, or failure to thrive. Pests of agricultural plants include, but are not limited to, plant mites, aphids, thrips, lepidopteran, dipteran, coleopteran, hemipteran, crickets, locusts, ants, cockroaches, flies, wasps, termites, woodworm, bookworm, silverfish, carpet beetles and moths. In one aspect, the pest may be the leek moth (Acrolepiopsis assectella), the diamondback moth (Plutella xylostella), the cotton bollworm (Helicoverpa armigera), the codling moth (Cydia pomonella), the lightbrown apple moth (Epiphyas postvittana), the gypsy moth (Lymantria dispar), the corn earworm (Helicoverpa zea), the indianmeal moth (Plodia interpunctella), the light brown apple moth (Epiphyas postvittana), the silkworm (Bombyx mori), the European corn borer (Ostrinia nubilalis), Duponchelia fovealis. In another aspect, the pest may be the European corn borer (Ostrinia nubilalis).

As used herein, the expression “survival rate” refers to the number of biological agents capable of treating or controlling a pest after a treatment of either immersion in an aqueous solution as disclosed herein or mechanical spreading on a surface as disclosed herein, divided by the total number of biological agents before the treatment. In one aspect, the survival rate corresponds to the emergence ratio of Trichogramma ostriniae pupae after an immersion in an aqueous solution as disclosed herein. The emergence ratio (or rate) after immersion corresponds to the ratio between (1) the number of emerged pupae and (2) the initial number of pupae before immersion. The emergence ratio after immersion is at least 50%, at least 60%, at least 70%, at least 80%, at least 90% or at least 95%. In another aspect, the survival rate corresponds to the emergence ratio of Trichogramma ostriniae pupae after a mechanical spreading on a surface, preferably corn leaves. The emergence ratio after mechanical spreading corresponds to the ratio the quotient between the number of emerged pupae in a period of about 0 to 10 days post mechanical spreading and the initial number of pupae before mechanical spreading. The emergence ratio after mechanical spreading is at least 50%, at least 60%, at least 70%, at least 80%, at least 90% or at least 95%.

As used herein, the expression “mechanical spreading” refers to spreading of a formulation, a composition, an aqueous solution, a biological agent and/or biopesticide suspension which is spread on large areas of land or large surfaces, by means of an apparatus. In one particular aspect, wherein the biological agent is in the form of an aqueous solution or suspension, the liquid is applied to a surface by spraying with a sprayer.

As used herein, the term “surface” refers to a surface onto which of a formulation, a composition, an aqueous solution, a biological agent and/or biopesticide is mechanically spread. Examples of such surfaces include, without limitation, a garden, a greenhouse, a forest or an agricultural field. More specifically a garden, a greenhouse, a forest or an agricultural field may comprise crops and/or plants such as, but not limited to, field crops (canola, cereals, corn, beans, forages, soybeans, or any combination thereof), fruit crops (apples, berries, grapes, tender fruits, or any combination thereof), vegetable crops, speciality crops (agroforestry, herbs, tobacco, turfs, hemp, ginseng, hops, or any combination thereof). More specifically, the surface may be a plant, parts of a plant or the surroundings of a plant, a leaf, seed, soil, stem, branch, root or any combination thereof. Even more specifically, the surface may be the upper or underside of the leaf of a plant or a crop. In one aspect, the surface is the upper or underside of corn leaves.

As used herein, the expression “irreversible and/or insoluble film” refers to a state of a formulation, a composition, an aqueous solution and/or biopesticide suspension following mechanical spreading on a surface, wherein the formulation, composition, aqueous solution and/or biopesticide suspension is dried into a film, or a thin layer containing the biological agent. Once formed on the surface this film is insoluble and therefore it is not possible to return to the liquid state of the formulation, composition, aqueous solution and/or biopesticide suspension under natural conditions.

As used herein, the term “adhesion” (vertical) refers to sufficient adhesion between a formulation, a composition, an aqueous solution and/or biopesticide suspension, either in their liquid state or once dried into an irreversible and/or insoluble film, and the surface onto which they were mechanically spread so that the formulation, composition, aqueous solution and/or biopesticide suspension does not fall off the surface during intended use. Adhesion between the formulation, the composition, the aqueous solution and/or the biopesticide suspension, either in their liquid state or once dried into an irreversible and/or insoluble film, and the surface onto which they were mechanically spread, may occur whatever the orientation of the surface is relatively to the ground. For example, the surface may be oriented vertically or horizontally relatively to the ground.

As used herein, the expression “resistant to leaching caused by rain and/or wind” refers to the ability of a formulation, a composition, an aqueous solution and/or a biopesticide suspension to adhere to the surface onto which it has been mechanically spread when subjected to different weather conditions including rain and/or wind. Resistance to leaching caused by rain and/or wind can be measured with the adhesion rate which corresponds to the difference between the initial and the final number of biological agent following submission of the formulation, composition, aqueous solution and/or biopesticide suspension to wind and/or rain on the surface, divided by the initial number of biological agent.

In one aspect, the adhesion rate of the formulation, composition, aqueous solution and/or biopesticide suspension on the surface after submission of at least one episode of rain and/or wind is at least 40%, at least 50%, at least 60%, at least 70%, at least 80%, at least 90% or at least 95%.

As used herein, the term “spraying apparatus” refers to a means for applying an aqueous solution and/or a biopesticide suspension to a surface, typically comprising a pump, valves, tank, hoses, and at least one nozzle. Spraying apparatus include, but are not limited to, portable sprayers such as backpack sprayers, greenhouse sprayers, sprayers mounted on an aircraft (aerial application sprayers) or sprayers mounted on a tractor (terrestrial application sprayers).

### Detailed Description of Particular Embodiments

### Sprayer Apparatus

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

Moreover, although the embodiments of the spraying apparatus and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation therebetween, as well as other suitable geometrical configurations, may be used for the spraying apparatus, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

Moreover, it will be appreciated that positional descriptions such as “above”, “below”, “forward”, “rearward” “left”, “right” and the like should, unless otherwise indicated, be taken in the context of the figures and correspond to the position and orientation of the spraying apparatus and corresponding parts, with the “front” corresponding to a position closer to a front of the spraying apparatus and the “back” corresponding to a position closer to a back of the spraying apparatus. Positional descriptions should not be considered limiting.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the following description, the term “about” means within an acceptable error range for the particular value as determined by one of ordinary skill in the art, which will depend in part on how the value is measured or determined, i.e. the limitations of the measurement system. It is commonly accepted that a 10% precision measure is acceptable and encompasses the term “about”.

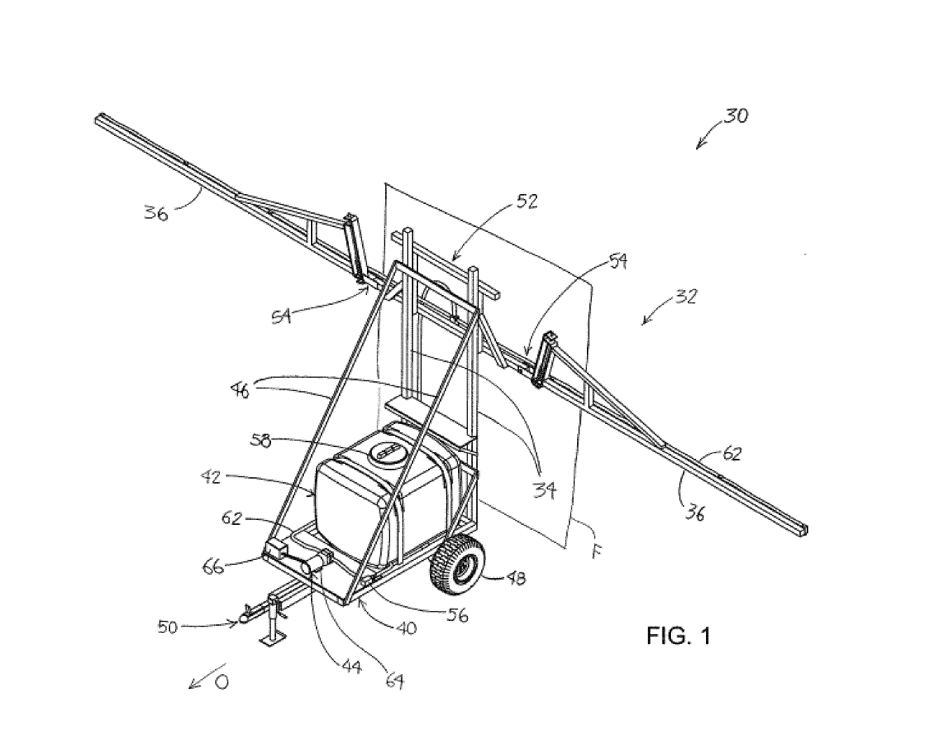

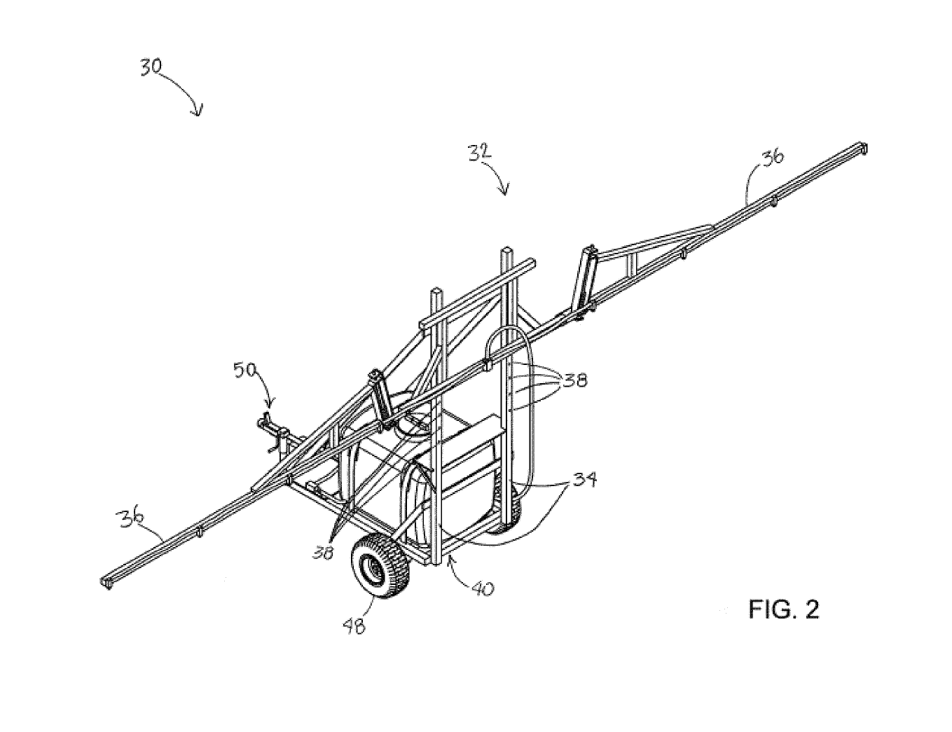

Referring to FIGS. 1 to 4, there is shown an embodiment of a spraying apparatus 30 for spraying a biological agent suspended in a viscous solution. Pesticides are typically applied to crops, plants, their leaves or other biological targets by spraying. As will be described in further details below, a mechanical sprayer is used to deliver the biological agent to control pest. More specifically, the solution comprises Trichogramma pupae to control the corn borer. The aqueous solution has a viscosity sufficient to maintain the pupae evenly scattered and in suspension in the solution while allowing pumping of the solution. The solution must also present a viscosity sufficient to adhere to the leaves of the sprayed plants and to form a rain-resistant film on the leaves. In the following description, the viscous aqueous solution is also referred to as a viscous liquid. It will be appreciated that the spraying apparatus described below may be used for delivering a variety of pesticides for multiple applications in agriculture and should not be restricted to the application of Trichogramma pupae to control the corn borer.

In the embodiment shown, the spraying apparatus 30 comprises a framework 32 designed to support the components of the spraying apparatus. The framework 32 comprises a pair of lateral frame posts 34 that define a spraying height H with respect to a ground surface. The framework 32 further comprises a pair of support arms 36 extending on opposite sides of the pair of lateral frame posts 34 to define a spraying width W. In the following description, the support arms 36 are also referred to as boom assemblies 36. The support arms may be provided with multiple reinforcing members (not shown) configured in different truss shapes according to the overhang length of the support arms.

In a non-limitative embodiment (not shown), the framework comprises a single lateral frame post and a single support arm that extends on either side of the lateral frame post. In another non-limitative embodiment (not shown), the framework comprises a single lateral frame post and a pair of support arms that extends on opposite sides of the lateral frame post.

In the embodiment shown, the spraying height H, defined as the height of the support arm(s) with respect to a ground surface, is adjustable. The support arms 36 are removably mounted to the lateral frame posts 34. More specifically, the lateral frame posts 34 and the support arms 36 comprise a plurality of height adjustment holes 38 for adjusting the height H of the support arms 36 and securing the supports arms 36 with mechanical fasteners (not shown). The support arms 36 extend substantially horizontally from the lateral frame posts 34, but it can be appreciated that the support arms 36 can extend angularly with respect to a ground surface, i.e. slightly downwardly or slightly upwardly with respect to a ground surface. It can also be appreciated that in an alternative embodiment (not shown), the support arms, or at least a portion of, extend substantially vertically from the lateral frame posts.

In an alternative embodiment (not shown), the spraying apparatus comprises a frame, a supply tank adapted to contain the viscous aqueous solution, spray nozzles spaced apart along the frame and configured to spray the viscous aqueous solution and a positive displacement pump in fluid communication with the supply tank and the spray nozzles, the pump being adapted to receive the viscous aqueous solution from the supply tank and deliver the viscous aqueous solution at a predetermined spraying pressure to the spray nozzles. In this embodiment, the frame, the supply tank, the spray nozzles and the positive displacement pump are sized and configured for aerial spraying. Aerial spraying includes, but is not limited to, application of the aqueous solution using an aircraft, helicopter and unmanned aerial vehicles such as drones.

In an alternative embodiment (not shown), the frame, the supply tank, the spray nozzles and the positive displacement pump are sized and configured for greenhouse spraying.

In an alternative embodiment (not shown), the frame, the supply tank, the spray nozzles and the positive displacement pump are sized and configured for portable spraying. Portable spraying includes, but is not limited to, a hand-held spraying apparatus, and a spraying apparatus integrated to a backpack worn by a user for manual spraying.

In the embodiment shown, the framework 32 further comprises a platform 40 extending substantially horizontally and onto which a supply tank 42 and a pump 44 are removably mounted, as described in further details below. As shown, the lateral frame posts 34 extend upwardly from the platform 40. The framework 32 also includes bracing arms 46 extending between the platform 40 and the lateral frame posts 34.

In a non-limitative embodiment, the spraying apparatus 30 includes a pair of wheels 48 mounted on opposite sides of the platform 40.

In an alternative embodiment (not shown), the spraying apparatus includes a single wheel mounted to the platform. It can be appreciated that the wheel(s) can be mounted to the platform or to the lateral frame posts. It can also be appreciated that the spraying apparatus can be stationary, or be movable with other moving means than wheels.

The spraying apparatus 30 further comprises a towing structure 50 secured to the framework 32 that is adapted to be attached to a tow vehicle (not shown). The tow vehicle can be an all-terrain vehicle such as and without being limitative an agricultural tractor. The spraying apparatus 30 is adapted to be towed so that spraying of the solution containing the biological agent may be carried efficiently at small or large scale.

It can be appreciated that the lateral frame posts 34, support arms 36, platform 40, bracing arms 46 and towing structure 50 are secured together with mechanical fasteners but other joining methods such as welding may be used.

As shown on FIG. 1, the lateral frame posts 34 and the support arms 36 define a frame plane F and the spraying apparatus 30 is movable in an operation direction O that is substantially normal to the frame plane F.

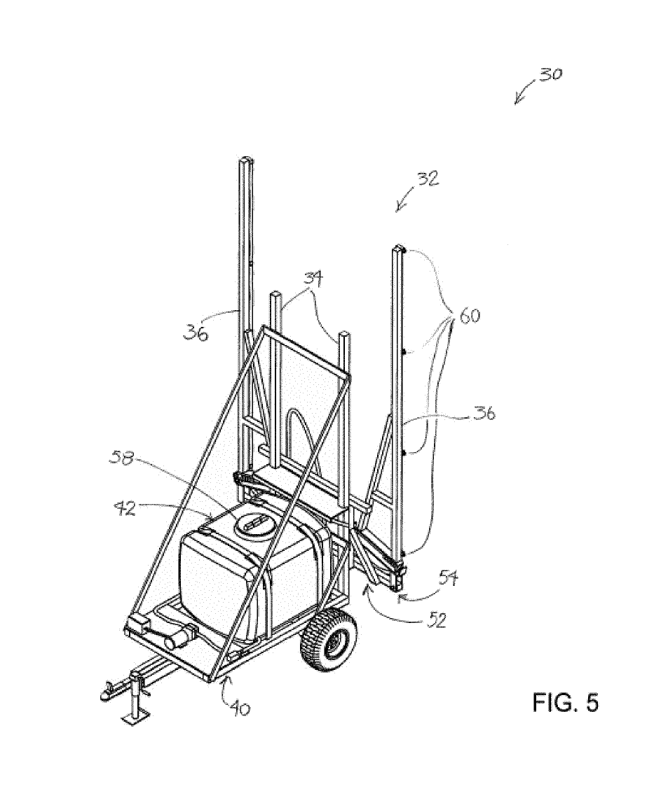

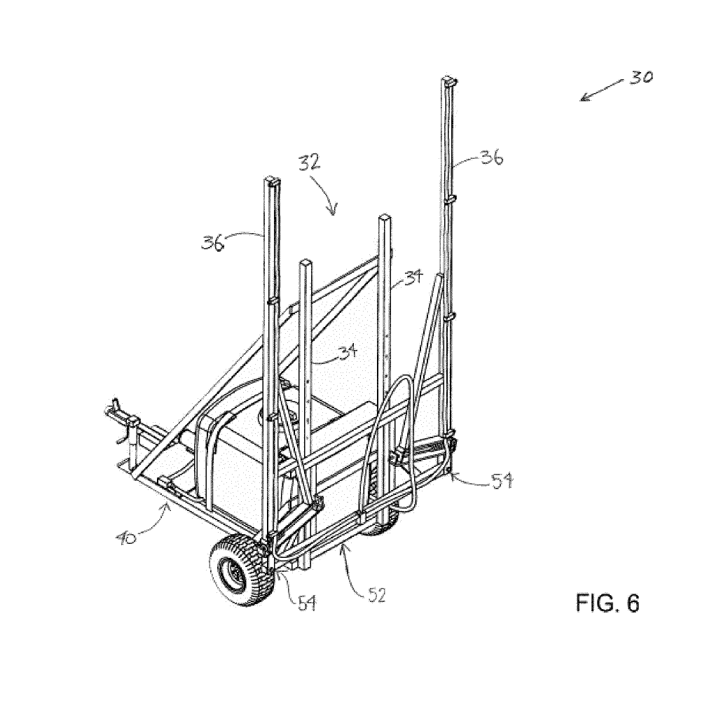

As shown on FIGS. 1, 5 and 6, the framework 32 further comprises a boom support structure 52. The boom assemblies 36, previously referred to as support arms 36, are hingedly connected to the boom support structure 52 and can thus pivot upwardly in the transport configuration as described below. The boom support structure 52, and thus the boom assemblies 36, are slidably mounted to the lateral frame posts 34. The hinges 54 allow the spraying apparatus 30 to be selectively configurable in a transport configuration and an operation configuration. In the operation configuration, the support arms 36 extend outwardly from the lateral frame posts 34. In the transport configuration, the support arms 36 are folded on opposite sides of the lateral frame posts 34 and extend substantially parallel to the lateral frame posts 34.

In the embodiment shown, the spraying apparatus 30 further comprises a supply tank 42 removably attached to the platform 40. The supply tank 42 is adapted to contain the viscous aqueous solution and is in fluid communication with the pump 44 as mentioned below. The spraying apparatus 30 also comprises a control valve 56 for controlling the flow of the viscous aqueous solution between the supply tank 42 and the pump 44. The control valve 56 may be used, for instance, during a maintenance operation such as cleaning or replacing a component. The supply tank 42 includes a sealable inlet 58 for receiving the viscous aqueous solution. The viscous aqueous solution does not require mixing during the spraying operation to keep the Trichogramma pupae scattered within the solution.

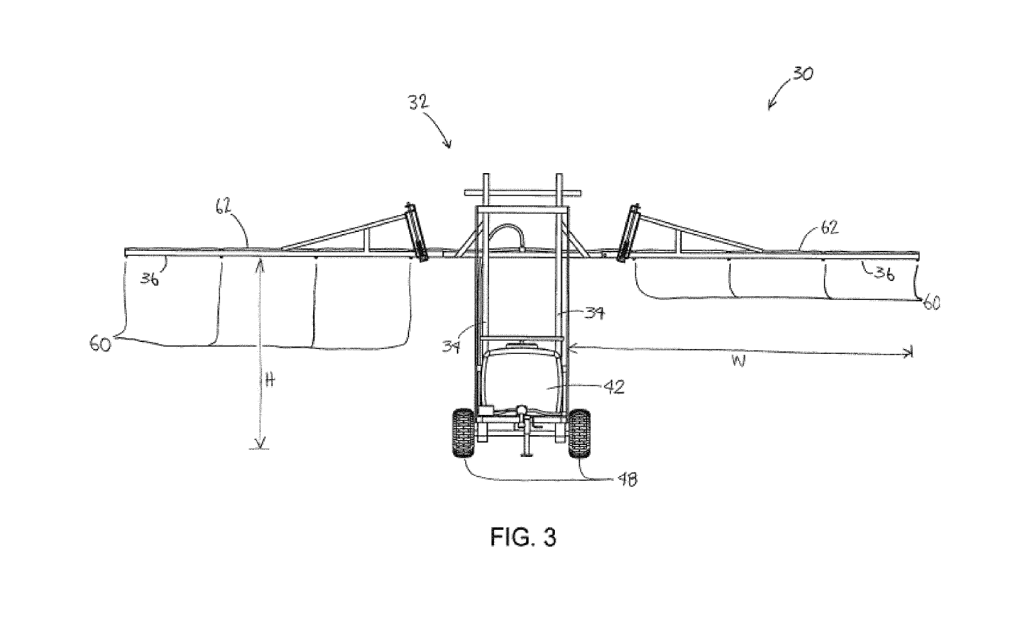

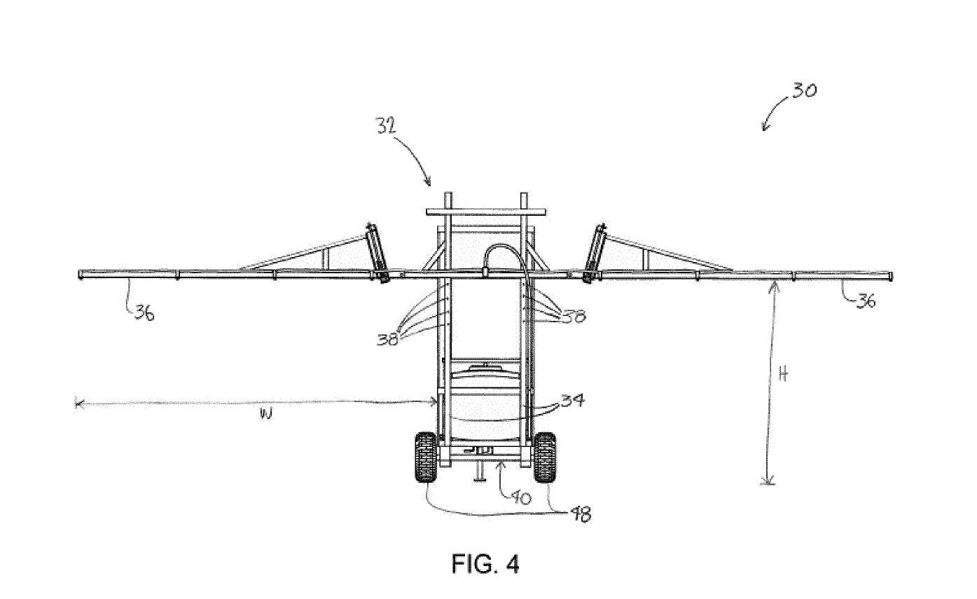

Referring to FIGS. 3 and 4, it is shown that the spraying apparatus 30 comprises a plurality of spray nozzles 60 that are spaced apart along the spraying width W. It can be appreciated that each support arm 36 can comprise a single spray nozzle 60 or a plurality of spray nozzles 60 that can be evenly spaced apart or unevenly distributed along the spraying width W. As mentioned above, the framework 32 can include a single support arm 36 or a pair of support arms 36 extending horizontally on opposite sides of the pair of lateral frame posts 34. The spray nozzles 60 are secured to the support arms 36 and directed substantially downwardly. In an alternative embodiment (not shown), the spray nozzles can be directed substantially frontwardly, rearwardly or upwardly. As described in further details below, flexible tubing 62 extends along the support arms 36 and along the lateral frame post(s) to ensure fluid communication between the spray nozzles 60 and the pump 44.

In a non-limitative embodiment, the spray nozzles 60 have flat spray tips. In an embodiment, the spray nozzles are sized and shaped to allow spraying the viscous aqueous solution at a pressure ranging between about 10 and 50 psi. In another embodiment, the spray nozzles are sized and shaped to allow spraying the viscous aqueous solution at a pressure ranging between about 15 and 20 psi. Considering the size of the Trichogramma pupae, i.e. a length of about 0.57 mm and a width of about 0.30 mm, the spray nozzles 60 have an outlet orifice larger than about 0.3 mm, preferably larger than about 0.4 mm, more preferably larger than about 0.5 mm, and most preferably larger than 0.57 mm.

Now referring to FIG. 1, it is shown that the spraying apparatus 30 comprises the pump 44 that is mounted to the platform 40. The pump 44 is in fluid communication with the supply tank and the spray nozzles 60 with flexible tubing 62 and is powered by a battery 66. The pump 44 is adapted to receive the viscous aqueous solution from the supply tank 42 and deliver the viscous aqueous solution at a predetermined spraying pressure to the spray nozzles 60. In an embodiment, the predetermined spraying pressure ranges between 15 and 20 psi. In an embodiment, the pump 44 can be a positive displacement pump, such as and without being limitative, a diaphragm pump. The positive displacement pump is sized to deliver the viscous aqueous solution to the spray nozzles 60 at a flow rate between 4 L/min and 55 L/min. The spraying apparatus 30 does not include a pressure regulator since it has been shown to damage the pupae. Therefore, the spraying apparatus 30 comprises a pressure switch 64 that is operatively connected to the positive displacement pump to protect the components of the spraying apparatus in case of clogging of the tubing 62 for example. In a non-limitative embodiment, the pressure switch 64 is set at 50 psi. Other components typically used in spraying devices, such as filters and spray nozzles having non-return valves and anti-drip features, may damage pupae and are thus not included in the spraying apparatus 30. Instead of being controlled by a pressure regulator, the spraying pressure is controlled by the flow rate of the pump and the type and quantity of spray nozzles. In a non-limitative embodiment, the flow rate of the positive displacement pump ranges between 4 L/min and 55 L/min and eight spray nozzles of the Teejet brand, model XR110, size 08 are used. Accordingly, tubing diameter ranges between about 1.6 cm and 2 cm.

As can be appreciated, the viscous aqueous solution contained in the supply tank has an initial viscosity and an initial pupae emergence rate. The initial viscosity allows an even dispersion of the pupae in the aqueous solution. The viscous aqueous solution is subjected to shear stress when flowing through the pump and through the spray nozzles. Therefore, the viscosity of the sprayed solution is lower than the initial viscosity, but sufficient to form a film on a sprayed surface. The spray nozzles are shaped and sized so that the sprayed pupae emergence rate is substantially equal to the initial pupae emergence rate. It can be appreciated that other types of pump than the diaphragm pump type and spray nozzles that can deliver and spray a viscous liquid at the pressure ranges mentioned above without damaging the Trichogramma pupae can be used.

It will be appreciated that the methods described herein may be performed in the described order, or in any suitable order.

### Formulation

Herein presented is a demonstration that a specific formulation of xanthan and guar gums is required to ensure proper suspension of Tricogramma pupae for even spreading and high enough survival rates to ensure adequate pest protection.

In some aspects, there is provided a formulation comprising an aqueous solution of xanthan gum and guar gum for use in making a suspension for a biological agent. It should be understood that the concentration of xanthan gum and guar gum in the aqueous solution may respectively vary from less than 1 g/L, 1 g/L, 2 g/L, 3 g/L, 4 g/L, 5 g/L, 6 g/L, 7 g/L, 8 g/L, 9 g/L to 10 g/L or more. It should also be understood that the aqueous solution may comprise xanthan gum and guar gum respectively in the concentrations listed above and in a ratio of about 1:10, 2:5, 3:10, 2:5, 1:2, 3:5, 7:10, 4:5 or 1:1. For example, in one particular embodiment, the formulation may include xanthan gum in aqueous solution at a concentration between about 1 to 7 g/L, preferably between about 1 to 5 g/L, even more preferably between about 1 to 3, and most preferably at 2 g/L. For example, in another particular embodiment, the formulation may include guar gum in aqueous solution at a concentration between about 1 to 7 g/L, preferably between about 1 to 5 g/L, even more preferably between about 1 to 3 g/L, and most preferably at 2 g/L. In another particular embodiment, xanthan gum and guar gum may be in a ratio of about 3:5 to 5:3 in aqueous solution, preferably in a ratio of about 1:1.

In some aspects, the formulation further comprises a biological agent suspended therein. It should be understood that the biological agent can include an insect, a mite, or any combination thereof, as defined herein in the definition section. For example, in one particular embodiment, the biological agent can be an insect at different stage of its development, such as, but not limited to an egg, a larva, a pupae or an adult. For example, in another particular embodiment, the biological agent can be a mite at different stage of its development, such as, but not limited to an egg, a larva, a protonymph, a deutonymph or an adult. In another particular embodiment, the insect can be from the genus Trichogramma, as defined herein in the definition section, preferably from the specie Trichogramma ostriniae, and even more preferably a Trichogramma ostriniae pupae.

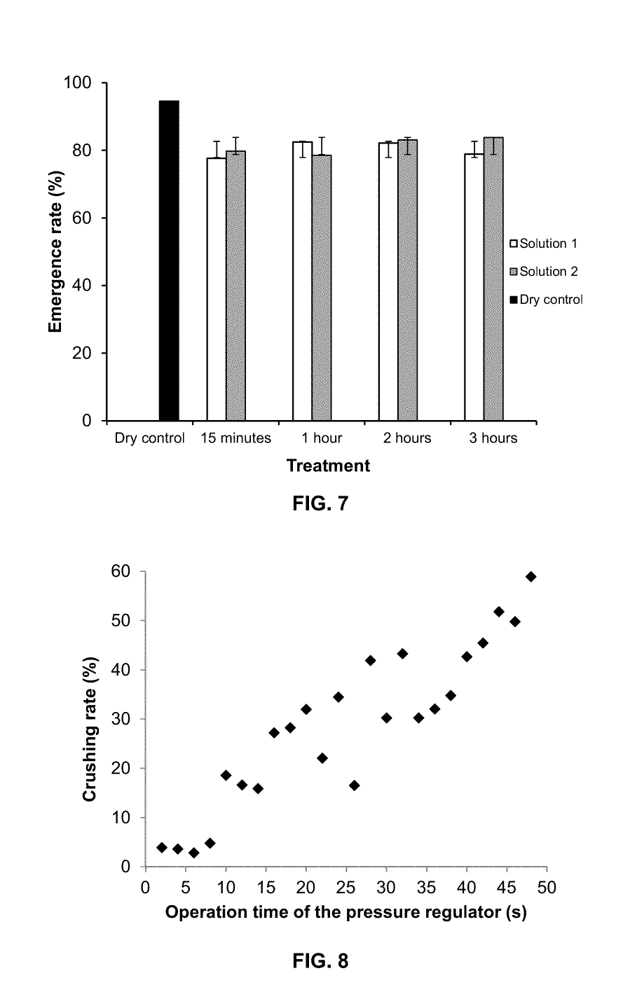

In some aspects, the biological agent suspended in the formulation has a survival rate of at least 50% after a 10 hours immersion in the formulation. It should be understood that the immersion in the formulation can be less than 5 minutes, 5 minutes, 10 minutes, 15 minutes, 30 minutes, 45 minutes, 1 hour, 2 hours, 3 hours, 4 hours, 5 hours, 10 hours or more. It should also be understood that the survival rate can be at least 50%, at least 60%, at least 70%, at least 80%, at least 90% or at least 95%. For example, in one particular embodiment, the survival rate can correspond to the emergence ratio of Trichogramma ostriniae pupae after an immersion of 15 minutes, 1 hour, 2 hours or 3 hours in a formulation as defined herein (FIG. 7). In this particular embodiment, the emergence ratio (or rate) after immersion corresponds to the ratio between the number of emerged pupae in a period of about 10 days post immersion and the initial number of pupae before immersion and the emergence ratio after immersion is at least 80%.

### Composition for Spreading

In some aspects, there is provided a composition comprising xanthan gum and guar gum in aqueous solution for use in mechanical spreading of a biological agent on a surface. It should be understood that the concentration of xanthan gum and guar gum in the composition may respectively vary from less than 1 g/L, 1 g/L, 2 g/L, 3 g/L, 4 g/L, 5 g/L, 6 g/L, 7 g/L, 8 g/L, 9 g/L to 10 g/L or more. It should also be understood that the composition may comprise xanthan gum and guar gum respectively in the concentrations listed above and in a ratio of about 1:10, 2:5, 3:10, 2:5, 1:2, 3:5, 7:10, 4:5 or 1:1. For example, in one particular embodiment, the composition may include xanthan gum in aqueous solution at a concentration between about 1 to 7 g/L, preferably between about 1 to 5 g/L, even more preferably between about 1 to 3, and most preferably at 2 g/L. For example, in another particular embodiment, the composition may include guar gum in aqueous solution at a concentration between about 1 to 7 g/L, preferably between about 1 to 5 g/L, even more preferably between about 1 to 3 g/L, and most preferably at 2 g/L. In another particular embodiment, xanthan gum and guar gum may be in a ratio of about 3:5 to 5:3 in aqueous solution, preferably in a ratio of about 1:1.

In some aspects, the composition further comprises a biological agent suspended therein. It should be understood that the biological agent can include an insect, a mite, or any combination thereof, as defined herein in the definition section. For example, in one particular embodiment, the biological agent can be an insect at different stage of its development, such as, but not limited to an egg, a larva, a pupa or an adult. For example, in another particular embodiment, the biological agent can be a mite at different stage of its development, such as, but not limited to an egg, a larva, a protonymph, a deutonymph or an adult. In another particular embodiment, the insect can be from the genus Trichogramma, as defined herein in the definition section, preferably from the specie Trichogramma ostriniae, and even more preferably a Trichogramma ostriniae pupae.

### Surface

In some aspects, the surface onto which the composition is mechanically spread can be a forest, a garden, a greenhouse, an agricultural field, or any combination thereof, as defined herein in the definition section. In one particular embodiment, the surface comprises a crop and/or a plant. As defined herein in the definition section, it should be understood that crops and/or plants can be crops and/or plants such as, but not limited to, field crops (canola, cereals, corn, beans, forages, soybeans, or any combination thereof), fruit crops (apples, berries, grapes, tender fruits, or any combination thereof), vegetable crops, speciality crops (agroforestry, herbs, tobacco, turfs, hemp, ginseng, hops, or any combination thereof). It should also be understood that the surface may be a crop and/or plant, parts, surroundings, leaves, seeds, soil, stems, branches, roots or any combination thereof. Even more specifically, the surface may be the upper or underside of the leaf of a plant or a crop. In one aspect, the surface is the upper or underside of corn leaves. For example, in another particular embodiment, the surface is corn crops, preferably corn leaves, even more preferably the upper or underside of corn leaves.

In some aspects, the biological agent suspended in the composition has a survival rate of at least 50% after being spread on the surface. It should be understood that the survival rate can be at least 50%, at least 60%, at least 70%, at least 80%, at least 90% or at least 95%. For example, in one particular embodiment, the survival rate can correspond to the emergence ratio of Trichogramma ostriniae pupae after a mechanical spreading on a surface, preferably on corn leaves. In this particular embodiment, the emergence ratio after mechanical spreading corresponds to the ratio between the number of emerged pupae in a period of about 10 days post mechanical spreading and the initial number of pupae before mechanical spreading, and the emergence ratio after mechanical spreading is at least 80%.

In some aspects, the composition can be adapted to dry into an irreversible and/or insoluble film after mechanical spreading on the surface. It should be understood that after mechanical spreading on a surface, the composition can be dried into a film, or a thin layer containing the biological agent. Once formed on the surface this film can be insoluble and therefore it can be impossible to return to the liquid state of the composition under natural conditions. For example, in one particular embodiment, the composition is dried into an irreversible and/or insoluble film after mechanical spreading a corn leaves.

In some aspects, the composition adheres to the surface after mechanical spreading. It should be understood that sufficient adhesion between the composition, either in its liquid state or once dried into an irreversible and/or insoluble film, and the surface onto which it was mechanically spread means that the composition does not fall off the surface during intended use. Adhesion may occur whatever the orientation of the surface is relatively to the ground. For example, the surface may be oriented vertically or horizontally relatively to the ground. In one particular embodiment, the composition can adhere to an upper and/or under side of crops and/or plants, preferably corn leaves, after mechanical spreading.

In some aspects, the composition, when spread on the surface, is resistant to leaching caused by rain and/or wind. It should be understood that resistance to leaching caused by rain and/or wind can be measured with the adhesion rate which corresponds to the difference between the initial and the final number of biological agent following submission of the composition to an episode of wind and/or rain on the surface, divided by the initial number of biological agents in the composition. The adhesion rate of the biopesticide suspension on the surface after submission of at least one episode of rain and/or wind can be at least 40%, at least 50%, at least 60%, at least 70%, at least 80%, at least 90% or at least 95%. For example, in one particular embodiment, the adhesion rate of the composition after at least one episode of rain and/or wind is at least 95% (FIG. 13).

In some aspects, the mechanical spreading of the biological agent suspended in the composition is carried out by spraying. More specifically, spraying can be performed with the spraying apparatus as defined herein.

### Method

In another aspect, there is provided a method for control and/or treatment of a pest. In some embodiment, the method includes making a formulation comprising xanthan gum and guar gum, as defined herein, wherein xanthan gum and guar gum are each at concentrations between 1 to 7 g/L, obtaining a biological agent as defined herein, suspending the biological agent in the formulation to form a biopesticide suspension, and mechanically spreading the biopesticide suspension on a surface. It should be understood that the formulation can be made by using respectively any concentrations of xanthan gum and guar gum, and any ratio between these concentrations, as defined herein. It should also be understood that the biological agent can be any biological agent as defined herein. It should also be understood that the formulation comprising xanthan gum and guar gum, as well as the biological agent can be provided either separately or already combined in a biopesticide suspension before mechanically spreading the biopesticide suspension on a surface.

In some aspects, the method further includes pouring the biopesticide suspension in the spraying apparatus as defined herein and spraying the biopesticide suspension on the surface.

In some aspects of the method, the surface onto which the biopesticide suspension is mechanically spread can be a forest, a garden, a greenhouse, an agricultural field, or any combination thereof, as defined herein in the definition section. In one particular embodiment, the surface comprises a crop and/or a plant. As defined herein in the definition section, it should be understood that crops and/or plants can be crops and/or plants such as, but not limited to, field crops (canola, cereals, corn, beans, forages, soybeans, or any combination thereof), fruit crops (apples, berries, grapes, tender fruits, or any combination thereof), vegetable crops, speciality crops (agroforestry, herbs, tobacco, turfs, hemp, ginseng, hops, or any combination thereof). It should also be understood that the surface may be a crop and/or plant, parts, surroundings, leaves, seeds, soil, stems, branches, roots or any combination thereof. Even more specifically, the surface may be the upper or underside of the leaf of a plant or a crop. In one aspect, the surface is the upper or underside of corn leaves. For example, in another particular embodiment, the surface is corn crops, preferably corn leaves, even more preferably the upper or underside of corn leaves.

In some aspects of the method, the biological agent suspended in the formulation has a survival rate of at least 50% after being mechanically spread on the surface. It should be understood that the survival rate can be at least 50%, at least 60%, at least 70%, at least 80%, at least 90% or at least 95%. For example, in one particular embodiment, the survival rate can correspond to the emergence ratio of Trichogramma ostriniae pupae after a mechanical spreading on a surface, preferably on corn leaves. In this particular embodiment, the emergence ratio after mechanical spreading corresponds to the ratio between the number of emerged pupae in a period of about 10 days post mechanical spreading and the initial number of pupae before mechanical spreading, and the emergence ratio after mechanical spreading is at least 80%.

In some aspects of the method, the biopesticide suspension can be adapted to dry into an irreversible and/or insoluble film after mechanical spreading on the surface. It should be understood that after mechanical spreading on a surface, the biopesticide suspension can be dried into a film, or a thin layer containing the biological agent. Once formed on the surface this film can be insoluble and therefore it can be impossible to return to the liquid state of the biopesticide suspension under natural conditions. For example, in one particular embodiment, the biopesticide suspension is dried into an irreversible and/or insoluble film after mechanical spreading a corn leaf.

In some aspects of the method, the biopesticide suspension adheres to the surface after mechanical spreading. It should be understood that sufficient adhesion between the biopesticide suspension, either in its liquid state or once dried into an irreversible and/or insoluble film, and the surface onto which it was mechanically spread means that the biopesticide composition does not fall off the surface during intended use. Adhesion may occur whatever the orientation of the surface is relatively to the ground. For example, the surface may be oriented vertically or horizontally relatively to the ground. In one particular embodiment, the composition can adhere to an upper and/or under side of crops and/or plants, preferably corn leaves, after mechanical spreading.

In some aspects of the method, the biological agent, when spread on the surface, is resistant to leaching caused by rain and/or wind. It should be understood that resistance to leaching caused by rain and/or wind can be measured with the adhesion rate which corresponds to the difference between the initial and the final number of biological agent following submission of the biological to an episode of wind and/or rain on the surface, divided by the initial number of biological agents in the composition. The adhesion rate of the biopesticide suspension on the surface after submission of at least one episode of rain and/or wind can be at least 40%, at least 50%, at least 60%, at least 70%, at least 80%, at least 90% or at least 95%. For example, in one particular embodiment, the adhesion rate of the biopesticide suspension after at least one episode of rain and/or wind is at least 95% (FIG. 13).

In some aspects of the method, the pest to be controlled and/or treated is a plant, a virus, a bacterium, a fungus, an insect, a mite, an animal, or any combination thereof. As defined in the definition section, it should be understood that the pest to be controlled can be any pest that negatively affect animals and/or plants by colonizing, attacking or infecting them, and includes those organisms that spread disease and/or damage the animal and/or plant and/or compete for host nutrients. In one particular embodiment, the pest to be controlled and/or treated is Ostrinia nubilalis.

### Kit

In another aspect, there is provided a kit for the control and/or treatment of a pest. In one embodiment, the kit includes xanthan gum, guar gum, instructions for making a formulation of the guar gum and xanthan gum, instructions for suspending a biological agent in the solution, and instructions for spreading the solution on a surface. It should be understood that the formulation can be made by using respectively any concentrations of xanthan gum and guar gum, and any ratio between these concentrations, as defined herein. Therefore, the kit may comprise respectively xanthan gum and guar gum in concentrations varying from less than 1 g/L, 1 g/L, 2 g/L, 3 g/L, 4 g/L, 5 g/L, 6 g/L, 7 g/L, 8 g/L, 9 g/L to 10 g/L or more.

In another aspect, the kit further comprises the biological agent. It should be understood that the biological agent can be any biological agent as defined herein.

In another aspect, the kit further comprises a container. It should be understood that this container is intended for the preparation of the formulation of guar gum and xanthan gum, and for the further suspension of the biological agent in the formulation. The container may have any shape.

In another aspect, there is provided a composition comprising a biological agent suspended in a solution on xanthan gum and guar gum. In one embodiment, the biological agent is Trichogramma ostriniae pupae. It should be understood that the composition can comprise respectively any concentrations of xanthan gum and guar gum, and any ratio between these concentrations, as defined herein. It should also be understood that the biological agent can be any biological agent as defined herein.

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### EXAMPLES

### Example 1—Trichogramma pupae

Laboratory trials were carried out using the Trichogramma ostriniae pupae provided by Anatis Bioprotection inc. (Saint-Jacques-le-Mineur, Québec, Canada). Upon their reception, the pupae were kept at 4° C. before using them at the room temperature.

### Example 2—Pupae Immersion in Viscous Solutions

To homogeneously disperse Trichogramma pupae in the sprayer tank and allow them sticking on the leaves after being sprayed, different viscous solutions were explored.

Preferably, the viscous solution should:
Allow the dispersion of Trichogramma pupae in the volume of liquid;
Allow the adhesion of a drop on corn leaves;
Allow the formation of an insoluble film once dried;
Be non-toxic for Trichogramma pupae;
Be soluble at room temperature;
Be certified organic;
Preferably, be obtainable at low cost.

Drowning resistance of pupae was assessed through immersion trials in two types of viscous solutions (solution 1 and solution 2). Solution 1 was a guar gum solution at 7 g/L with distilled water and solution 2 was a xanthan gum solution at 5 g/L with distilled water. Approximately 4 000 pupae were mixed with 400 mL of solution 1. The same procedure was repeated with solution 2. After 15 minutes of immersion, 100 mL was sampled from each solution vessel and pupae were filtrated and rinsed with tap water. Rinsed pupae were then spread in Whatman filtration papers. The same process was repeated after 1 hour, 2 hours, and 3 hours of immersion. Pupae were left at room temperature for 11 days or until the emergence of all surviving Trichogramma is completed. A control treatment (not immersed pupae) was also considered for comparison reasons. After emergence, a microscope counting was done to determine total emerged and died pupae. Approximately 400 pupae per treatment were counted. The emergence rate was computed based on the number of died pupae and that of initially immersed pupae.

Obtained results showed a significant difference between dry control and immersed treatments (FIG. 7). However, both solution types and immersion time did not have any significant effect on the emergence of pupae.

The immersion in both solutions was significantly different compared to the dry control (Table 1). The solution type did not have any significant effect on the emergence of pupae. Emergence rates of pupae after being immersed in solutions 1 and 2 for 15 minutes to 3 hours are comparable for both solutions. The significant difference between dry control and immersed pupae could be attributed to the filtration and separation processes before microscope counting as they may have induced some damages to the pupae.

TABLE 1
Contrasts for immersion trials in solutions 1 and 2.

| | Degrees of | | |
|---|---|---|---|
| | Freedom | F-Value | p-Value |
| Control vs. solution 1 (15 min) | 1 | 47.81 | <.0001 |
| Control vs. solution 1 (3 hrs) | 1 | 40.99 | <.0001 |
| Control vs. solution 2 (15 min) | 1 | 36.18 | <.0001 |
| Control vs. solution 2 (3 hrs) | 1 | 18.85 | 0.0004 |
| Solution 1 (15 min) vs. solution 2 | 1 | 0.81 | NS |
| (15 min) | | | |
| Solution 1 (3 hrs) vs. solution 2 (3 hrs) | 1 | 4.25 | NS |
| Solution 1: 15 min vs. 1 hr to 3 hrs | 1 | 3.18 | NS |
| Solution 2: 15 min vs. 1 hr to 3 hrs | 1 | 1.04 | NS |

NS = not significant.

### Example 3—Pupae Spraying

A backpack sprayer was modified by integrating a diaphragm pump and a 12 volt battery. A pressure switch was used instead of a pressure regulator to avoid damaging the Trichogramma pupae. Indeed, preliminary spraying tests results revealed a low emergence rate due to the use of a pressure regulator, as shown in FIG. 8. FIG. 8 shows the crushing rate of pupae as a function of the operating time of the diaphragm pump with a pressure regulator. The longer the pump was operated, the larger was the number of pupae going through the pressure regulator and damaged. Hence, another system without a pressure regulator was necessary. Various number of solutions were explored by using a positive pump without regulator and controlling the pressure by choosing the type and number of nozzles and their orifice diameter.

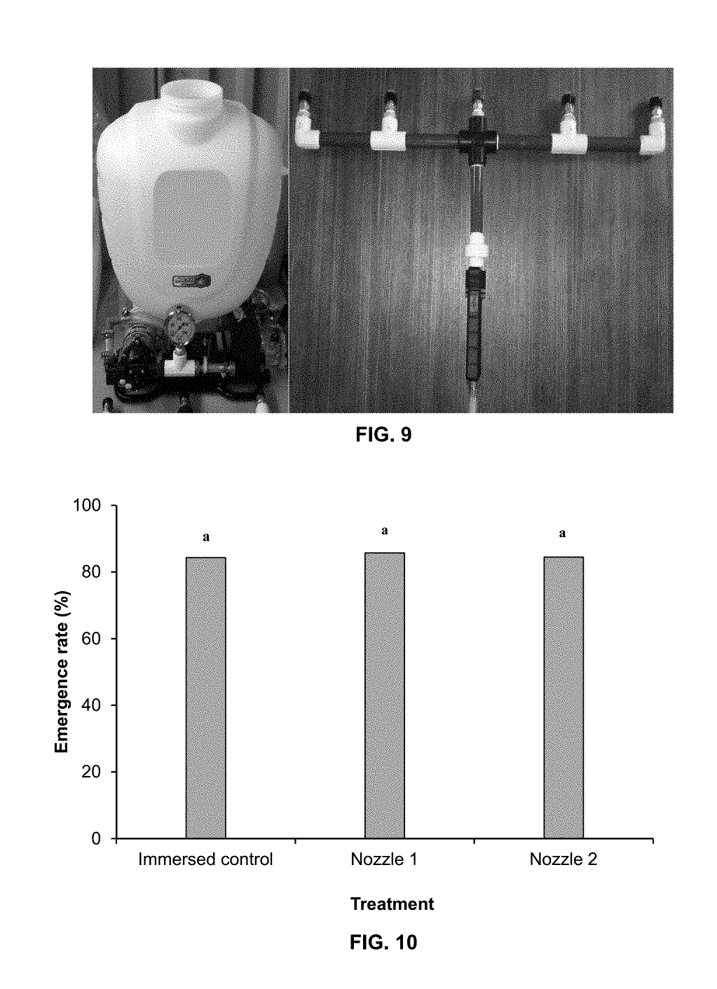

A five-nozzle spraying boom was used with different types of spraying tips to allow adjusting the pressure and the flow rate during spraying tests. FIG. 9 shows the sprayer used for the trials.

The spraying impact on pupae was assessed using solution 2 at lowest concentration with tap water (3 g/L) since it is easy to mix and generates less foam compared to solution 1. Around 200 000 Trichogramma ostriniae pupae were mixed with 3 L of solution 2. Two types of nozzle, nozzle 1 (XR Teejet 11004 VS) and nozzle 2 (XR Teejet 11006 VS) were used to adjust the spraying pressure and the flow rate. Samples of the mixture of spray solution and pupae were taken as control from the sprayer tank before spraying. Each treatment was replicated twice. 100 mL samples were filtered and rinsed with tap water and left 11 days at room temperature before computing the emerging rate using a microscope.

Obtained emergence rates of sprayed and immersed and not sprayed (control) pupae are presented in FIG. 10. The emergence rates of sprayed pupae are comparable to that of immersed control. This indicates that the pump and nozzles used with solution 2 are not harmful to Trichogramma pupae.

### Example 4—Pupae Adhesion on Corn Leaves and Resistance to Rain

Preliminary field spraying trials showed that both aqueous solutions 1 and 2 are susceptible to leaching by rain. Pupae adhesion on leaves until emergence is crucial since soil microclimate can be harmful for them. For this purpose, rain resistance of many solutions has been evaluated in the laboratory. More specifically, an insoluble solution once dried was needed. A synergic mixture of xanthan gum and guar gum was reported in the literature, where viscosity of the mixture was increased in comparison with each component considered separately. As such, viscosity measurements were performed in laboratory with a rotational viscometer to assess the features of the xanthan gum and guar gum mixture.

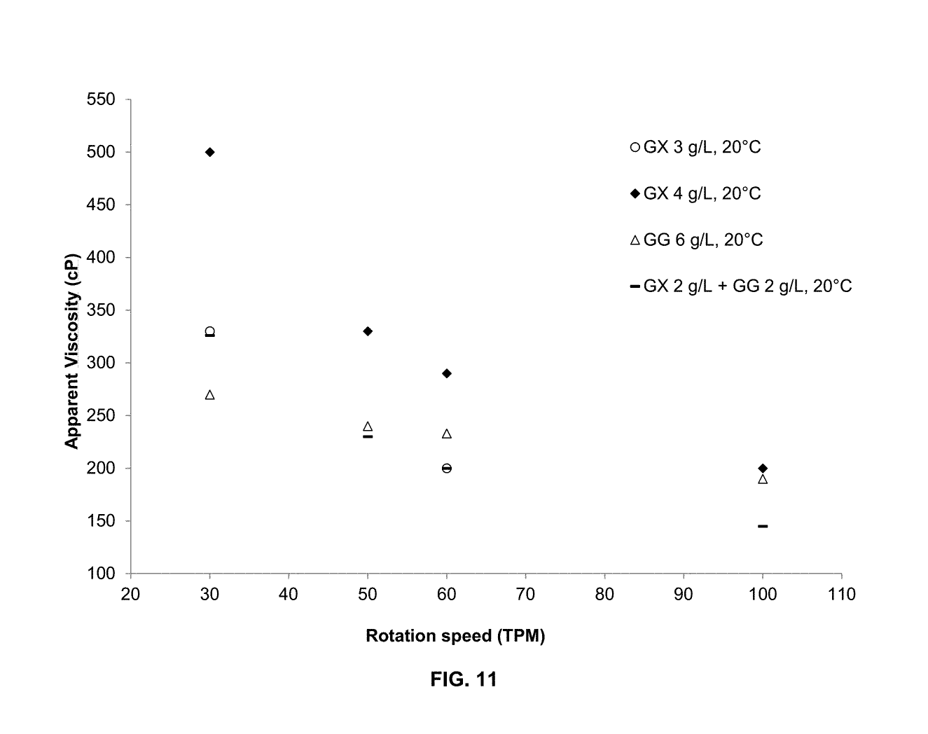

FIG. 11 presents a diminution of the apparent viscosity when the rotation speed of the rotative rod increases, especially for the solutions containing xanthan gum. As an increase of the rotation speed of the rod is proportional to an increase of the shear rate, it is therefore possible to confirm the pseudoplasticity of these solutions. This phenomenon is valuable herein since viscosity decreases when the solution goes through the pump and the nozzles, which allows the solution to flow more easily through the pump.

As for the synergic mixture of xanthan gum and guar gum, it is reported in the scientific literature that the synergy is observed between 80° C. and 90° C. Therefore, no synergic effect was expected, since xanthan gum and guar gum were solubilized at ambient temperature. Nonetheless, it has been observed that the mixture could form an irreversible and insoluble gel once dried, as explained below. In other words, a mixture of xanthan gum 2 g/L and guar gum 2 g/L allowed pseudoplasticity of the solution, as well as the formation of an irreversible and insoluble gel once dried.

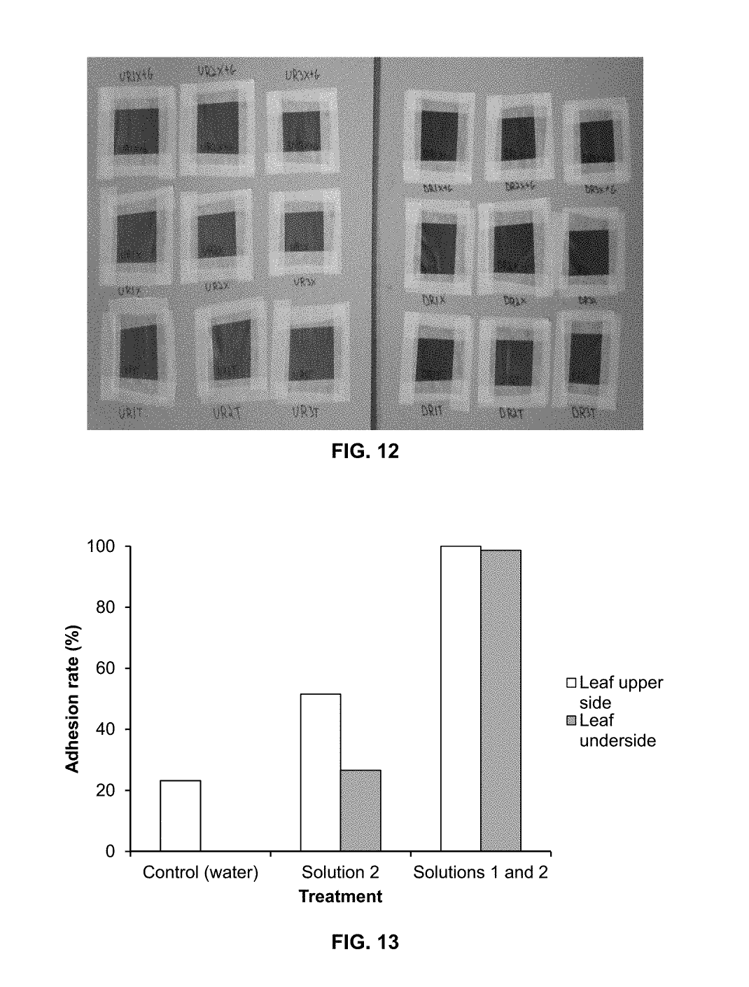

Adhesion to plant leaves and rain resistance experiments were also performed in laboratory. A control treatment consisting on pupae immersed in only water was considered. Solution 2 (4 g/L) was assessed at a higher concentration to determine the effect of this latter on solubility. Finally, a mixture of solutions 1 and 2 was evaluated based on three replicates. Each solution was mixed with pupae and approximately 1 mL of the solution was dropped on the upper side of corn leaves. The same process was replicated on the underside of corn leaves. Leaf samples were let dry for 24 hours and then a microscope counting was done. FIG. 12 illustrates the experimental setup. After spraying water on the samples to simulate the rain, another count was made to determine the adhesion rate of pupae. The adhesion rate corresponds to the difference between the initial and the final number of pupae, divided by the initial number of pupae.

FIG. 13 shows that the solution containing xanthan gum and guar gum provides an increased adhesion rate compared to the control and the solution containing xanthan gum only. For the solution containing xanthan gum and guar gum, treatments on both sides of the leaves showed improved resistance to rain simulation, compared with the control and the solution containing only xanthan gum. These results clearly indicate that the side of the leaves did not have any significant effect on the adhesion rate of pupae, in particular when using a mixture of solutions 1 and 2. However, the solution type had a significant effect on the adhesion of pupae on leafage by the formation of an insoluble gel upon drying that ensured resistance to water leaching.

### Example 5—Statistical Analysis

An analysis of variance (ANOVA) was performed on the data using the GLM procedure of the SAS software (version 9.3). Quantitative contrasts were done to compare the treatments.

### CONCLUSIONS

Based on the obtained results, the followings conclusions can be drawn:
The immersion time from 15 minutes to up to 3 hours in solutions 1 and 2 did not have any effect on the emergence rate of pupae.
The sprayer with a pressure regulator yields a low emergence rate of Trichogramma pupae.
When using the sprayer of the present invention, the emergence rate of sprayed pupae is comparable to that of immersed and non-sprayed pupae (control).
The adhesion of pupae on corn leaves is possible if the spraying solution is a mixture of xanthan and guar gums at particular concentrations and ratios.
The mixture of solutions 1 and 2 is surprisingly adequate in terms of adhesion of pupae on corn leaves under rain conditions simulated in the laboratory, considering that each solution independently, once dried, does not yield such rain resistance.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

All patents, patent applications and publications mentioned in this specification are herein incorporated by reference to the same extent as if each independent patent, patent application or publication was specifically and individually indicated to be incorporated by reference.

### REFERENCES

1. Boisclair, J., É. Lucas, D. Cormier, S. Todorova, and E. Etilé. (2011). Optimisation de la lutte biologique contre la pyrale du maïs et les pucerons dans la culture de maïs sucre frais. MAPAQ—Programme de soutien a l'innovation en agroalimentaire.
2. Ferland, C., L. Lauzon, Conseil des productions végétales du Québec, Programme d'aide à l'innovation technologique (Canada), and Plan vert du Canada. 2000. Lutte biologique contre la pyrale du maïs à l'aide de trichogrammes dans la culture du maïs sucré.
3. Gardner, J., and K. Giles. 1997. Mechanical Distribution of Chrysoperla rufilabrisand Trichogramma pretiosum: Survival and Uniformity of Discharge after Spray Dispersal in an Aqueous Suspension. Biol. Control: 138-142.
4. Jalali, S. K., K. S. Murthy, T. Venkatesan, Y. Lalitha, and P. S. Devi. 2005. Preliminary Testing of some New Release Methods for Egg Parasitoid Trichogramma spp.
5. Kienzle, J., O. Zimmermann, B. Wührer, P. Triloff, J. Morhard, E. Landsgesell, and C. P. W. Zebitz. 2012. New species and new methods of application-a new chance for Trichogramma in Codling Moth Control? In Stuttgart-Hohenheim, Germany.
6. Mills, N. J., L. Dixon, S. C. Welter, P. W. Weddle, and T. Wiseman. 1996. Trichogramma Augmentation as a Component of the Management of Codling Moth in Pears.
7. Morrison, R. K., M. Rose, and S. Penn. 1998. The effect of extended immersion in agitated liquid carriers on the viability of two entomophagous insects. Southwest. Entomol.: 131-135.
8. Musser, F. R., J. P. Nyrop, and A. M. Shelton. 2006. Integrating Biological and Chemical Controls in Decision Making: European Corn Borer (Lepidoptera: Crambidae) Control in Sweet Corn as an Example. J. Econ. Entomol. 99(5): 1538-1549.
9. Pereira, E. J. G., N. P. Storer, and B. D. Siegfried. 2008. Inheritance of Cry1F resistance in laboratory-selected European corn borer and its survival on transgenic corn expressing the Cry1F toxin. Bull. Entomol. Res. 98(6): 621.
10. Siegfried, B. D., and R. L. Hellmich. 2012. Understanding successful resistance management: The European corn borer and Bt corn in the United States. GM Crops Food 3(3): 184-193.
11. Zimmermann, O., and B. Wührer. 2010. Laboratory experiments to determine the liquid formulation for a spraying application technique for Trichogramma parasitized eggs to control the codling moth Cydia pomonella.

1. A mobile spraying apparatus for spraying crops with a viscous liquid, the spraying apparatus comprising:
a framework comprising a movable platform, a pair of frame posts extending upwardly from the platform to define a spraying height and boom assemblies extending on opposite sides of the frame posts to define a spraying width, the frame posts and the boom assemblies defining a frame plane and the platform being movable in an operation direction substantially normal to the frame plane;
a supply tank attached to the platform of the framework and adapted to contain the viscous liquid;
a plurality of spray nozzles evenly spaced apart along the spraying width and directed substantially downwardly, the nozzles being sized to spray the viscous liquid at a predetermined flow rate; and
a positive displacement pump mounted to the platform of the framework, the pump being in fluid communication with the supply tank and the plurality of spray nozzles, the pump being sized to receive the viscous liquid from the supply tank and deliver the viscous liquid at a predetermined spraying pressure to the spray nozzles.

2. The spraying apparatus of claim 1, wherein the spraying height is adjustable, wherein the boom assemblies are slidably mounted to the frame posts.

3. The spraying apparatus of claim 1, further comprising a boom support structure, the boom assemblies being hingedly connected to the boom support structure, the spraying apparatus being selectively configurable in a transport configuration and an operation configuration wherein the boom assemblies extend outwardly from the frame posts, the boom assemblies being folded on opposite sides of the frame posts and substantially parallel thereto in the transport configuration.

4. The spraying apparatus of claim 1, further comprising flexible tubing fluidly coupling the supply tank to the pump and the pump to the spray nozzles.

5. The spraying apparatus of claim 1, wherein the predetermined flow rate ranges between 4 L/min and 55 L/min.

6. The spraying apparatus of claim 1, wherein the predetermined spraying pressure ranges between 10 and 50 psi.

7. The spraying apparatus of claim 1, wherein the spray nozzles have an outlet orifice larger than about 0.30 mm.

8. A method for control and/or treatment of a pest on a surface comprising the steps of:
making a formulation comprising xanthan gum and guar gum, wherein xanthan gum and guar gum are each at concentrations between 1 to 7 g/L;
obtaining a biological agent;
suspending the biological agent in the formulation to form a biopesticide suspension; and
mechanically spreading the biopesticide suspension on the surface.

9. The method of claim 8, further comprising the step of:
pouring the biopesticide suspension in a spraying apparatus comprising:
a framework comprising a movable platform, a pair of frame posts extending upwardly from the platform to define a spraying height and boom assemblies extending on opposite sides of the frame posts to define a spraying width, the frame posts and the boom assemblies defining a frame plane and the platform being movable in an operation direction substantially normal to the frame plane;
a supply tank attached to the platform of the framework and adapted to contain the viscous liquid;
a plurality of spray nozzles evenly spaced apart along the spraying width and directed substantially downwardly, the nozzles being sized to spray the viscous liquid at a predetermined flow rate; and
a positive displacement pump mounted to the platform of the framework, the pump being in fluid communication with the supply tank and the plurality of spray nozzles, the pump being sized to receive the viscous liquid from the supply tank and deliver the viscous liquid at a predetermined spraying pressure to the spray nozzles;
spraying the biopesticide suspension on the surface.

10. The method of claim 8, wherein the biological agent comprises an insect from the genus Trichogramma.

11. The method of claim 8, wherein the biological agent has a survival rate of at least 50% after a 10 hours immersion in the formulation.

12. The method of claim 8, wherein xanthan gum and guar gum are in a ratio of about 3:5 to 5:3.

13. The method of claim 12, wherein xanthan gum and guar gum are in a ratio of about 1:1.

14. The method of claim 8, wherein the surface comprises a crop and/or a plant comprising leaves, the biopesticide suspension adhering to an upper and/or under side of the leaves after being mechanically spread.

15. The method of claim 8, wherein the crop comprises: field crops (canola, cereals, corn, beans, forages, soybeans, or any combination thereof), fruit crops (apples, berries, grapes, tender fruits, or any combination thereof), vegetable crops, specialty crops (agroforestry, herbs, tobacco, turfs, hemp, ginseng, hops, or any combination thereof).

16. The method of claim 8, wherein the pest is Ostrinia nubilalis.

17. A kit for the control and/or treatment of a pest, said kit comprising:
an aliquot of xanthan gum;
an aliquot of guar gum;
instructions for making a formulation of the guar gum and xanthan gum;
instructions for suspending a biological agent in the formulation; and
instructions for spreading the solution on a surface.

18. The kit of claim 17, further comprising the biological agent.

19. The kit of claim 17, wherein the biological agent is Trichogramma ostriniae pupae.

20. The kit of claim 17, further comprising a container.
